(19) United States
(12) Patent Application Publication
(10) Pub. No.: US 2007/0221752 A1
(43) Pub. Date: Sep. 27, 2007

(54) Liquid Feed Unit for a Liquid Spray Instrument and Liquid Spray Instrument Comprising Such a Liquid Feed

(76) Inventors: Xavier Bich, Neuilly Sur Seine (FR); Alain Rosenzweig, Saint Maur Des Fosses (FR); Kurt Rath, Herblay (FR)

Correspondence Address: JONES DAY, 222 EAST 41ST ST, NEW YORK, NY, 10017, US

(21) Appl. No.: 11/572,447

(22) PCT Filed: Jul. 5, 2005
(86) PCT No.: PCT/EP05/07976

§ 371 Date: Jan. 22, 2007

(30) Foreign Application Priority Data
Jul. 22, 2004 (FR) 04/08138

(51) Int. Cl. B43K 5/02

(52) U.S. Cl. 239/302

(57) ABSTRACT

A liquid feed unit intended to be mounted in a liquid spray instrument. The unit includes a liquid cartridge and a liquid spray head connected to the liquid cartridge. The liquid feed unit also comprises an energy supply source attached to the liquid cartridge so as to form a preassembled feed unit intended to be mounted directly in the liquid spray instrument.

The present invention relates to liquid feed units intended to be mounted in liquid spray instruments and to the liquid spray instruments comprising such feeds.

More particularly, the invention relates to a liquid feed unit that is intended to be mounted in a liquid spray instrument, and that comprises a liquid cartridge and a liquid spray head connected to the liquid cartridge.

Such a liquid feed unit is described in particular in French patent application FR 2 841 498. In this liquid feed unit, the liquid spray head is connected directly, in a fixed manner, to the liquid cartridge, thus forming a unit intended to be placed directly inside the instrument. This liquid spray instrument may, by way of example, be formed by a pen intended to be held in a user's hand. The writing instrument also comprises an integrated energy supply source that is independent of and separate from the liquid cartridge and from the liquid spray head, this energy supply source thus also being intended to be mounted inside the pen forming the liquid spray instrument.

Although the liquid spray instrument described in patent application FR 2 841 498 is entirely satisfactory, it can be understood how, when this instrument is assembled, the user must necessarily complete several assembly or disassembly steps, in particular when it is desired to change the liquid cartridge and/or the energy supply source. Moreover, the user may possibly be induced to place the energy supply source inside the instrument in the wrong direction, such that said instrument cannot then function.

The object of the present invention is to overcome these abovementioned drawbacks.

To this end, the subject of the invention is a liquid feed unit intended to be mounted in a liquid spray instrument, the said unit comprising:
a liquid cartridge, and
a liquid spray head connected to the liquid cartridge,
   characterized in that the said liquid feed unit also comprises an energy supply source attached to the liquid cartridge so as to form a pre-assembled feed unit intended to be mounted directly in the liquid spray instrument.

In preferred embodiments of the invention, one and/or other of the following arrangements may also be incorporated:
the liquid cartridge comprises a casing delimiting an internal liquid reservoir which extends between a first end and a second end extended by a tube that can allow the liquid to flow from the reservoir to the spray head;
the tube houses a capillary element to allow the liquid to be conveyed from the reservoir to the spray head;
the energy supply source is fitted, in a fixed manner, around the casing of the liquid cartridge;
the energy supply source is fixedly attached to the first end of the casing of the liquid cartridge;
the energy supply source is fitted, in a fixed manner, around the tube that extends from the second end of the casing of the liquid cartridge;
the energy supply source is formed by an electricity supply source having an outer wall on which are made electrical connections to electrically connect the said electricity supply source to at least one electrical component of the spray instrument, when the said liquid feed unit is mounted in the spray instrument;
the energy supply source is formed by a fuel chamber intended to be connected to a fuel cell placed in the spray instrument, when the said liquid feed unit is mounted in the spray instrument;
the liquid feed unit comprises means for refilling the level of liquid in the liquid cartridge; and
the liquid feed unit comprises means for recharging the energy level of the energy supply source.

Furthermore, the subject of the invention is also a liquid spray instrument comprising a liquid feed unit as defined above.

Other features and advantages of the invention will emerge from the following description of several embodiments thereof, given by way of non-limiting examples, in conjunction with the attached drawings.

In the drawings:

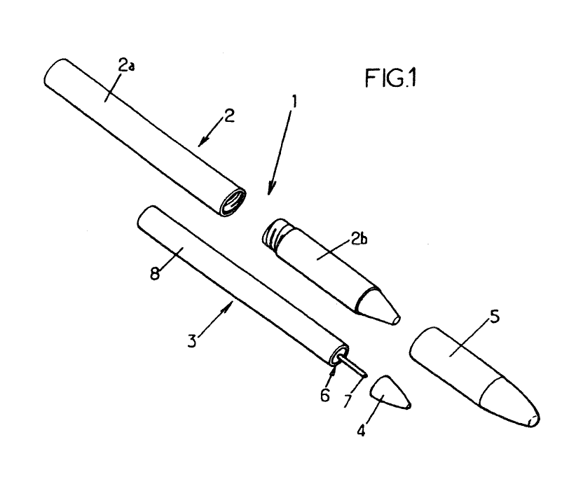

FIG. 1 is an exploded perspective view of a liquid spray instrument equipped with a liquid feed unit according to the invention;

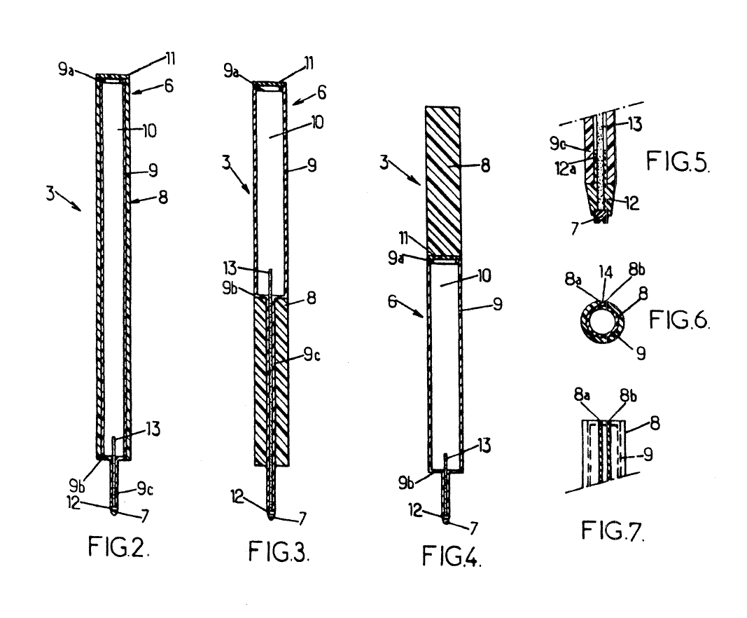

FIGS. 2 to 4 show various embodiments of the liquid feed unit according to the invention;

FIG. 5 is a view in longitudinal section showing, in detail, a system for fastening a liquid spray head to the liquid cartridge of the liquid feed unit according to the invention;

FIG. 6 is a view in transverse section of the liquid feed unit showing, in detail, its electrical connections for cooperating with electrical connections of complementary shape arranged in the liquid spray instrument;

FIG. 7 is a longitudinal view of a portion of the liquid feed unit with its electrical connections;

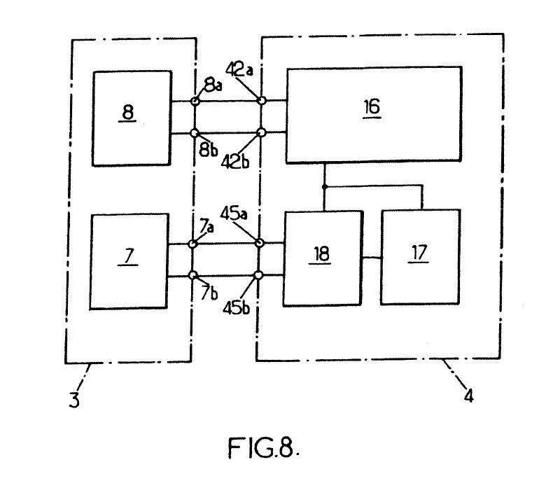

FIG. 8 is a block diagram of the various elements constituting the liquid feed unit and the spray instrument;

FIG. 9 is a view in partial section and in exploded perspective of part of the liquid feed unit before assembly with components of the spray instrument;

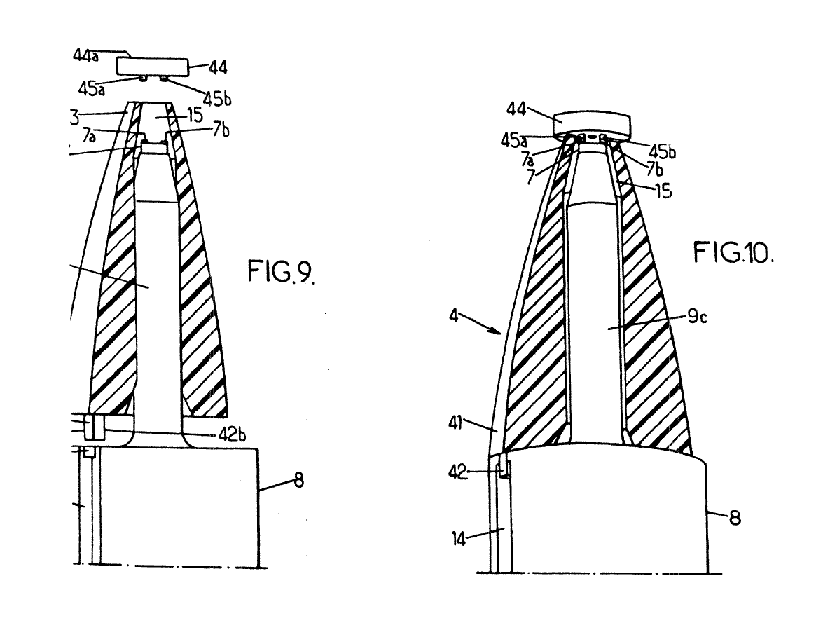

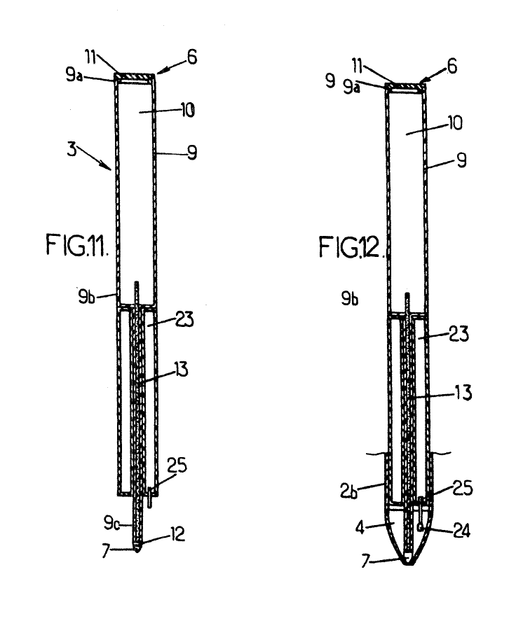

FIG. 10 is a view in partial section and in perspective of part of the liquid feed unit after assembly with components of the spray instrument;

FIG. 11 is a view in longitudinal section of the liquid feed unit according to yet another embodiment of the invention; and

FIG. 12 shows a view in longitudinal section of the liquid feed unit according to FIG. 11, with the feed unit assembled with components of the spray instrument.

In the various figures, the same references denote identical or similar elements.

FIG. 1 shows an embodiment of a liquid spray instrument such as a writing instrument 1 whose outer shape corresponds substantially to that of a pen, and which mainly comprises:
a barrel 2 that may be composed of two parts 2a, 2b intended to be fastened to one another, for example by screwing,
a liquid feed unit 3 intended to be mounted inside the barrel 2,
a control unit 4 intended to cooperate with the liquid feed unit 3 and also intended to be housed inside the barrel 2, and
a cap 5 intended to fit over the part 2b of the barrel 2 of the writing instrument 1.

The liquid feed unit 3 intended to be mounted in the barrel 2 mainly comprises:
a liquid cartridge 6, a liquid spray head 7 fixedly connected to the liquid cartridge 6, and
an energy supply source 8 attached to the liquid cartridge 6, this electrical energy supply source 8 possibly being formed by at least one electric battery or storage battery. This electricity supply source 8 may be rechargeable or non-rechargeable.

Thus, the liquid cartridge 6, the liquid spray head 7 and the electricity supply source 8 form a pre-assembled feed unit intended to be mounted directly inside the barrel 2 of the liquid jet writing instrument 1.

FIG. 2 shows a first embodiment of the liquid feed unit 3. According to this first embodiment, the liquid cartridge 6 comprises an elongate casing 9 of substantially tubular shape that runs between a first open end 9a and a second end 9b that is extended by a tube 9c made as a single piece with the second end 9b. This casing 9 delimits an internal reservoir in which the liquid is placed. To this end, the internal reservoir may contain an absorbent material 10 for retaining the liquid which, depending on the use made of the instrument, may be ink intended to be sprayed onto some kind of support. The first end 9a of the casing may also be closed off by a plug 11 that may have a through hole allowing communication between the internal reservoir and atmospheric pressure.

The casing 9 may also comprise means for refilling the level of liquid in the reservoir. These refill means may be located, for example, at the plug 11.

The free end of the tube 9c of the liquid cartridge 6 is intended to fixedly bear the liquid spray head 7. By way of example, and as shown in FIG. 5, the liquid spray head 7 may for example be fixedly attached to a support element 12 that has a duct 12a fitted directly in the end of the tube 9c. The duct 12a of the support element 12 is also designed to house a capillary element 13 that extends between a first end in contact with the absorbent material 10 and a second end associated with the spray head 7 so as to convey the liquid from the internal reservoir of the cartridge 6 to the spray head 7.

By way of example, the head 7 for spraying liquid, such as ink, may be formed by a piezoelectric-effect spray head or by a thermoresistive spray head that comprises one or more spray nozzles intended to spray liquid onto a writing support.

In this first embodiment shown in FIG. 2, the electricity supply source or electric battery 8 has a substantially tubular shape and directly surrounds the casing 9 of the liquid cartridge 6. This electricity supply source 8, extending between the first and second ends 9a, 9b of the casing 9 of the cartridge 6, may for example be fastened directly by adhesive bonding to the outer wall of the casing 9. This assembly formed by the cartridge 6, spray head 7 and electricity supply source 8 thus forms a pre-assembled feed unit that may be mounted directly inside the writing instrument.

To this end, the electricity supply source 8 also comprises, as can be seen in FIGS. 6 and 7, electrical connections 8a, 8b designed to be electrically connected to at least one electrical component of the writing instrument, when the said liquid feed unit 3 is mounted inside the barrel 2 of the writing instrument 1. These electrical connections 8a, 8b are formed by electrically conducting elements partially housed in a slot 14 made in the outer wall of the electricity supply source 8. These electrically conducting elements 8a, 8b have ends that extend beyond the slot 14 so as to come into contact with complementary electrical connections of at least one electrical component of the writing instrument 1.

FIG. 3 shows a second embodiment of the liquid feed unit 3.

According to this second embodiment, the casing 9 is shorter than the casing shown in FIG. 2. By contrast, the tube 9c extending from the second end 9b of the casing 9 is longer than the tube 9c shown in FIG. 2. In this second embodiment, the electricity supply source 8 is fitted directly around the tube 9c while bearing against the second end 9b of the casing 9. Naturally, as can be seen in FIG. 3, the capillary element 13 designed to convey the liquid from the reservoir to the spray head 7 has an appropriate length as a function of the length of the tube 9c. FIG. 4 shows a third embodiment of the feed unit. According to this third embodiment, the electricity supply source 8 is fixedly attached to the first end 9a of the casing 9 of the cartridge 6. More precisely, the electricity supply source 8 is fixedly attached to the plug 11 that provides an air communication between the internal reservoir formed by the casing 9 and the ambient air.

Naturally, it will be understood that, depending on the type of liquid spray instrument used, the liquid feed unit 3 may have any shape suitable for being housed in a housing of appropriate shape made inside the instrument.

By way of example, this liquid spray instrument may also consist of any instrument designed to be held in a user's hand that comprises a liquid cartridge, a liquid spray head and an integrated energy supply source.

Moreover, the dimensions and autonomy of the electricity supply source 8 will depend on the amount of energy to be supplied to the various electrical components of the instrument so as to spray all of the quantity of liquid contained in the cartridge 6 onto an appropriate support.

According to the various embodiments shown in FIGS. 2 to 4, the tube 9c has at least one section over which is intended to be fitted a control unit 4 designed to activate or not activate the liquid projection head 7 (see FIGS. 9 and 10). This control unit 4 may for example be placed permanently in the part 2b of the instrument 1 and cooperate with the liquid feed unit 3 when it is mounted in the instrument.

In the example considered here, this liquid spray control unit 4 is of substantially frustoconical outer shape with a duct 15 in which is designed to be housed the section of the tube 9c of the cartridge 6. Schematically, as can be seen in FIG. 8, this liquid spray control unit 4 mainly comprises:
an energy control unit 16 electrically connected to the connections 8a, 8b of the electricity supply source 8 of the liquid feed unit 3,
a detection and measurement device 17 designed to detect and measure parameters of use of the writing instrument 1, this detection and measurement device being electrically connected to the energy control unit 16, and

a processing unit 18 designed to command or not command the activation of the spray head 7 as a function of parameters detected and/or measured by the detection and measurement device 17.

By way of example, the detection and measurement device 17 may comprise measurement means for measuring, without physical contact between the writing instrument and the support, the distance between the spray head 7 and a support on which it is intended to deposit droplets of liquid. The detection and measurement device 17 may furthermore comprise movement detection means designed to detect the slightest movement of the writing instrument during use when the latter is held in the user's hand.

By way of example, the means for measuring the distance between the spray head 7 and the support and the movement detection means forming the detection and measurement device 17 may be identical to those already described in patent application FR 2 841 498.

Likewise, the logic for activating or not activating the spray head employed by the processing unit 18 may be identical to that already described in patent application FR 2 841 498.

FIGS. 9 and 10 show an exemplary embodiment of this liquid spray control unit 4. As already seen above, this control unit 4 is of substantially frustoconical 20, shape with a duct 15 in which is intended to be housed the section of the tube 9c that bears the liquid spray head 7. The frustoconical body of the control unit 4 has an end 41 from which there extends a projecting element 42 on which are arranged, on either side, 25 electrical connections 42a, 42b intended to come into electrical contact with the electrical connections 8a, 8b of the electricity supply source 8.

The electrical connections 42a, 42b make it possible to supply the energy control unit 16 located inside the control unit 4 of frustoconical shape. The other end 43 of the control unit 4 is designed to receive a chip 44 that has electrical connections 45a, 45b that electrically connect the processing unit 18 to the electrical connections 7a, 7b of the spray head 7.

The feed unit 3, or more precisely the tube 9c is fitted directly in the control unit 4 such that the electrical connections 7a, 7b of the spray head 7 come into contact with the connection 45a, 45b of the chip 44 secured to the control unit 4.

Moreover, the chip 44, which is intended to be fixedly attached to the end 43 of the control unit 4, may also have through holes that open out directly on its face 44a and are intended to be arranged facing the support onto which it is intended to spray the liquid droplets. These through holes may in particular serve to house an infrared LED sending an incident light beam in the direction of the writing support so as to create a light spot that will then be analysed by a photodiode, itself placed in a through hole in the chip 44. The principle of measuring a distance by means of an infrared LED and a photodiode is in particular described in patent application FR 2 841 498.

FIGS. 11 and 12 show another, embodiment of the invention. According to this embodiment, the energy supply source is formed by a fuel chamber 23 intended to supply fuel to a fuel cell 24 that may be, for example, placed inside the control unit 4.

To this end, the fuel chamber 23 comprises a connector 25 for conveying the fuel, for example methanol or the like, to the fuel cell 24.

Naturally, in this embodiment, the control unit 4 of the writing instrument 1 may also be provided with a energy control unit 16, a detection and measurement device 17 and a processing unit 18 as described above. The control unit 4 may also be fastened inside the part 2B of the instrument 1, a portion of which is shown in FIG. 12.

Furthermore, the fuel chamber 23 may also comprise means for refilling the level of fuel contained in the chamber 23, these refill means may, for example, be formed by the connector 25 or a suitable valve allowing the chamber to be refilled with fuel.

1.-11. (canceled)

12. A liquid feed unit comprising:
a liquid cartridge;
a liquid spray head connected to said liquid cartridge; and
an energy supply source attached to said liquid cartridge so as to form a pre-assembled feed unit capable of being disposed in a liquid spray instrument.

13. The liquid feed unit according to claim 12, wherein said liquid cartridge comprises a casing delimiting an internal liquid reservoir which extends between a first end and a second end, and is extended by a tube that allows liquid to flow from the reservoir to said spray head.

14. The liquid feed unit according to claim 13, wherein the tube houses a capillary element to allow the liquid to be conveyed from the reservoir to said spray head.

15. The liquid feed unit according to claim 13, wherein said energy supply source is fitted, in a fixed manner, around the casing.

16. The liquid feed unit according to claim 15, wherein said energy supply source is fixedly attached to a first end of the casing.

17. The liquid feed unit according to claim 13, wherein said energy supply source is fitted, in a fixed manner, around the tube that extends from the second end of the casing.

18. The liquid feed unit according to claim 12, wherein said energy supply source includes an outer wall on which are made electrical connections to electrically connect said electricity supply source to at least one electrical component of said spray instrument, when the said liquid feed unit is mounted in the spray instrument.

19. The liquid feed unit according to claim 12, wherein said energy supply source is formed by a fuel chamber capable of being connected to a fuel cell placed in said spray instrument, when said liquid feed unit is mounted in the spray instrument.

20. The liquid fee unit according to claim 13, further comprising means for refilling the level of liquid in said liquid cartridge.

21. The liquid fee unit according to claim 13, further comprising means for recharging an energy level of said energy supply source.

22. A liquid feed unit comprising:
a liquid cartridge;
a liquid spray head connected to said liquid cartridge; and
an energy supply source attached to the liquid cartridge so as to form a pre-assembled feed unit capable of being disposed in a writing instrument,
wherein said liquid cartridge comprises a casing delimiting an internal liquid reservoir which extends between a first end and a second end, and is extended by a tube that allows liquid to flow from the reservoir to said spray head, and
wherein said energy supply source is fixedly attached to the first end of the casing.

23. A liquid feed unit comprising:
a liquid cartridge;
a liquid spray head connected to said liquid cartridge; and
an energy supply source attached to the liquid cartridge so as to form a pre-assembled feed unit capable of being disposed in a writing instrument,
wherein said liquid cartridge comprises a casing delimiting an internal liquid reservoir which extends between a first end and a second end, and is extended by a tube that allows liquid to flow from the reservoir to said spray head, and
wherein said energy supply source is fitted, in a fixed manner, around the tube that extends from the second end of the casing.
